(19) United States
(12) Patent Application Publication
(10) Pub. No.: US 2017/0265638 A1
(43) Pub. Date: Sep. 21, 2017

(54) TOOTH BRUSH APPARATUS AND METHODS OF USE

(71) Applicants: Arslanbek Sagynaliev, Mundelein, IL (US); Chingis Aloev, Mundelein, IL (US)

(72) Inventors: Arslanbek Sagynaliev, Mundelein, IL (US); Chingis Aloev, Mundelein, IL (US)

(21) Appl. No.: 15/463,312

(22) Filed: Mar. 20, 2017

Related U.S. Application Data
(60) Provisional application No. 62/310,138, filed on Mar. 18, 2016.

(51) Int. Cl. A46B 9/04; A61C 17/34; A61C 17/22; A46B 5/00; A46B 13/02

(52) U.S. Cl. CPC A46B 9/045; A46B 5/0012; A46B 13/023; A61C 17/222; A61C 17/3436; A61C 17/3445; A46B 2200/1066

(57) ABSTRACT

A tooth brush apparatus is disclosed including a plurality of brush heads disposed on the top surface, the first side surface, and the second side surface of the top portion to clean every tooth in the human mouth.

### CROSS-REFERENCE TO RELATED APPLICATIONS

The present application claims priority to U.S. Provisional Application Ser. No. 62/310,138, filed Mar. 18, 2016, which is herein incorporated by reference in its entirety.

### BACKGROUND

The invention generally relates to tooth brushes.

The use of toothbrushes and the routine of brushing teeth on a daily basis is a well-established practice for the vast majority of people. A common toothbrush will typically have a handle which is grasped and held by the user, as well as a head portion. The head portion comprises a base which may be extension of the handle, and bristles mounted in the base and extending upwardly therefrom. The bristles are most often oriented in one plane, although they may have different lengths and mounting configurations in the base in an effort to optimize the efficiency of the toothbrush.

As is well known, the user moves the bristles over the teeth for the purpose of dislodging food particles or other debris in the tooth crevices and spaces between the teeth, and also for preventing the buildup of plaque or at least the rate at which plaque builds up on the teeth.

Different bristle configurations and toothbrush shapes have been developed and marketed over the years with the express objective of improving the effectiveness of the toothbrush, in order to maximize the consequence of the sweeping motion of the toothbrush to dislodge debris and reduce plaque buildup. The literature is replete with many designs and variations of toothbrushes. Different toothbrushes may work better with children or with adults, or with people with special needs and requirements in order to protect the teeth.

The teeth themselves vary from one person to another very substantially. Some people may have straight teeth while others may have teeth which are moderately or severely misaligned relative to each other. Further, each tooth has different types of surface. For example, the thickness of the enamel covering the teeth may vary depending on the location on the tooth. In this regard, it should be noted that the thickness of the enamel layer on the occlusal area, or the chewing surface, will be greater than the thickness of the enamel later on the sides of the teeth.

The present invention utilizes all or many of these factors in the design and construction of the toothbrush of the invention, which thus addresses physical aspects of the teeth in order to make the brushing process more productive in cleaning and caring for the teeth.

### SUMMARY OF THE INVENTION

Provided herein are systems, methods and compositions for a tooth brush apparatus. A tooth brush apparatus generally comprises: a mouthpiece configuration operably coupled to a handle, the mouth piece configuration including a top portion and a bottom portion, whereby the top portion and the bottom portion include a plurality of brush heads; the top portion includes a top surface, a first side surface, and a second side surface, the plurality of brush heads are disposed on the top surface, the first side surface, and the second side surface of the top portion; the bottom portion includes a top surface, a first side surface, and a second side surface, the plurality of brush heads are disposed on the top surface, the first side surface, and the second side surface of the bottom portion; and the plurality of brush heads are operably coupled to drive mechanism that provides a brushing action, and the plurality of brushing heads are configured on each surface of the top portion and the bottom portion to brush every tooth in a human mouth.

A tooth brush apparatus is disclosed and comprises a handle operably coupled to the brush head, wherein the brush head includes a first state and a second state; the first state is flexed out position of the brush head, whereby the bristles on the brush head open up and separate from adjacent bristles and decrease the density of the bristles per mm²; the first state of the brush head includes a generally curvilinear cross-section or profile; the second state of the brush head closes the bristles and causes the bristles to become compact and increase the density of bristles per mm².

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIG. 1A is a perspective view of one embodiment of the tooth brush apparatus.

FIG. 1B is a bottom view of one embodiment of the tooth brush apparatus taken from view 1B in FIG. 1A.

FIG. 1C is a bottom view of one embodiment of the bottom portion.

FIG. 2A is a perspective view of one embodiment of the tooth brush apparatus.

FIG. 2B is a bottom view of one embodiment of the tooth brush apparatus taken from view 2B in FIG. 2A.

FIG. 2C is a perspective view of one embodiment of the tooth brush apparatus.

FIG. 3A is a perspective view of one embodiment of the brush head.

FIG. 3B is a top view of one embodiment of the brush head.

FIG. 3C is a perspective view of one embodiment of the top or bottom portion.

FIG. 3D is a top view of one embodiment of the top or bottom portion.

FIG. 4A is a top view of one embodiment of the tooth brush apparatus.

FIG. 4B is a side view of one embodiment of the tooth brush apparatus.

FIG. 5A is a side view of one embodiment of the tooth brush apparatus in a first state.

FIG. 5B is a side view of one embodiment of the tooth brush apparatus in a second state.

FIG. 6A is a bottom perspective view of one embodiment of the tooth brush apparatus.

FIG. 6B is a side view of the brush head according to one embodiment.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein. The words proximal and distal are applied herein to denote specific ends of components of the instrument described herein. A proximal end refers to the end of an instrument nearer to an operator of the instrument when the instrument is being used. A distal end refers to the end of a component further from the operator and extending towards the surgical area of a patient and/or the implant.

The use of the terms “a” and “an” and “the” and similar referents in the context of describing the invention are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any non-claimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

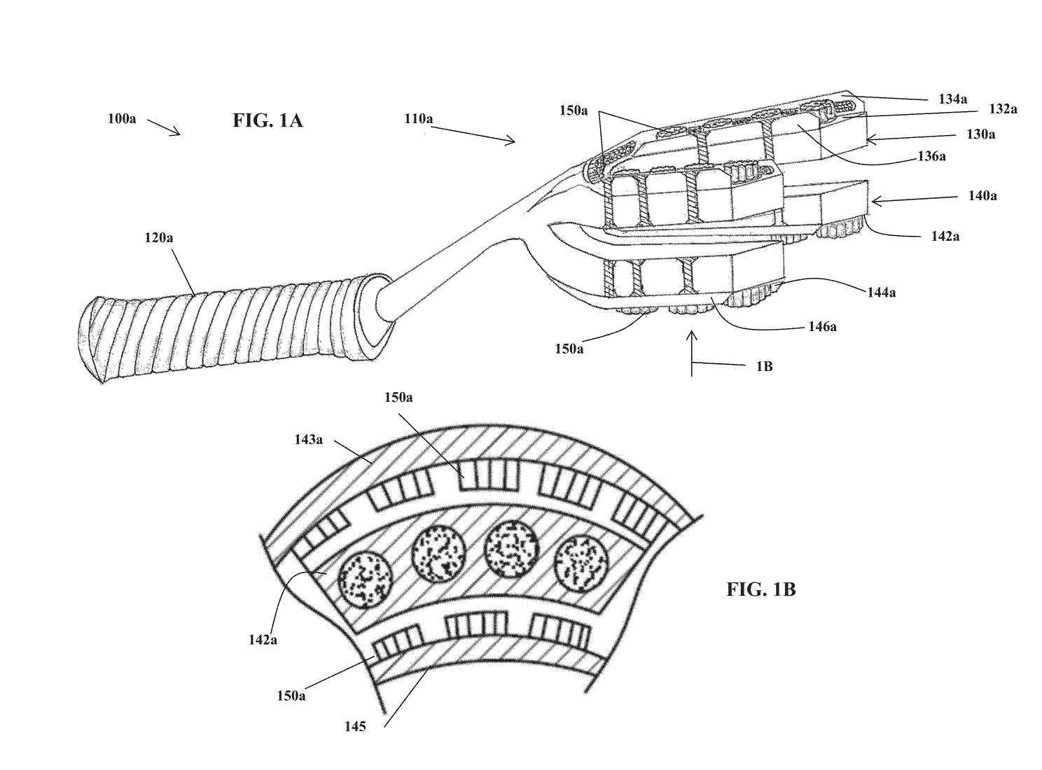

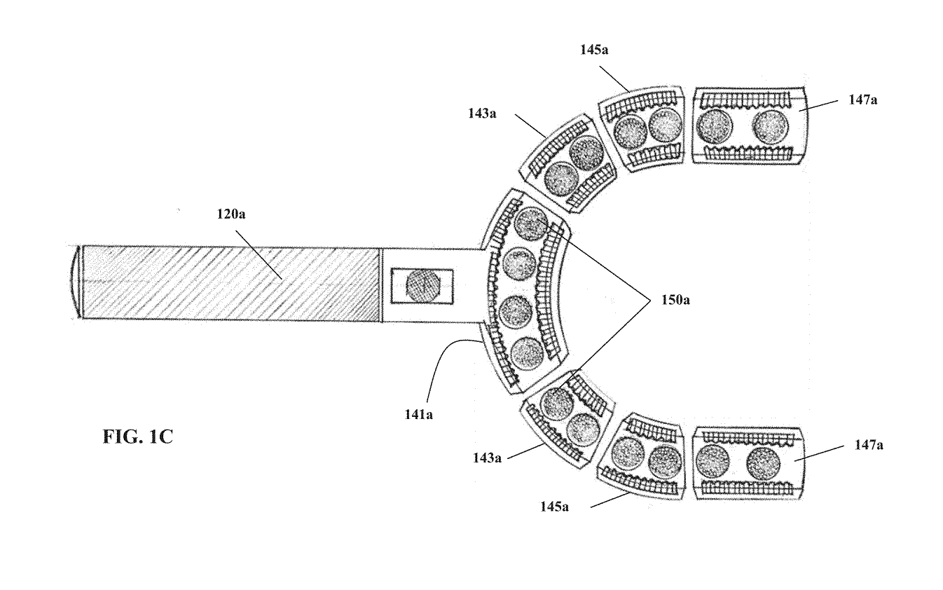

The tooth brush apparatus 100a is shown in FIG. 1A and comprises a mouthpiece configuration 110a operably coupled to a handle 120a. The mouth piece configuration 110a includes a top portion 130a and a bottom portion 140a, whereby the top portion 130a and the bottom portion 140a include a plurality of brush heads 150a. The top portion 130a includes a top surface 132a, a first side surface 134a, and a second side surface 136a. The bottom portion 140a includes a top surface 142a, a first side surface 144a, and a second side surface 146a. The plurality of brush heads 150a are disposed on the top surface 132a, the first side surface 134a, and the second side surface 136a of the top portion 130a. The plurality of brush heads 150 are disposed on the top surface 142a, the first side surface 144a, and the second side surface 146a of the bottom portion 140a. The plurality of brush heads 150a are operably coupled to drive mechanism that provides a brushing action, as further described below. The plurality of brushing heads 150a are configured on each surface of the top portion 130 and the bottom portion 140 to brush every tooth in a human mouth. A human mouth has 32 teeth, which (except for wisdom teeth) includes incisors (8 total): The middlemost four teeth on the upper and lower jaws; canines (4 total): The pointed teeth just outside the incisors; premolars (8 total): Teeth between the canines and molars; and molars (8 total). The plurality of brush heads 150a may be the same or different according to the different teeth being cleaned. Accordingly, the top portion 130a and the bottom portion 140a may include different sections of brush heads 150, as shown in FIG. 1B, to accommodate different teeth.

The bottom portion 140a is shown FIG. 1B for representative purposes but may also represent the top portion 130a. The bottom portion 140a a top surface 142a, a first side surface 144a, and a second side surface 146a. In one embodiment, the top surface 142a is set at angle with respect to the first side surface 144a and the second side surface 146a. In one embodiment, the angle is between 75 degrees and 110 degrees. The angle may be selected according to the type of teeth being cleaned or brushed and what section of the bottom portion 140a the brush heads are disposed. The top portion 130 may include a first section, a second section, a third section, and fourth section (not shown). The bottom portion includes a first section, a second section, a third section, and fourth section. The first section may be adapted for the incisors, the second section may be adapted for the canines, the third section may be adapted for the premolars, and fourth section may be adapted for the molars.

In one embodiment, the bottom portion 140a is shown FIG. 1C for representative purposes but may also be the top portion 130a. The bottom portion 140a includes a first section 141a, a second section 143a, a third section 145a, and fourth section 147a. The top portion 130a may include a first section, a second section, a third section, and fourth section (not shown). The first section may be adapted for the incisors, the second section may be adapted for the canines, the third section may be adapted for the premolars, and fourth section may be adapted for the molars. Alternatively, the top portion may be adapted for the teeth on the maxillary bone or top jaw bone, while the bottom portion may be adapted for teeth on the mandible bone or bottom jaw bone, as further described below.

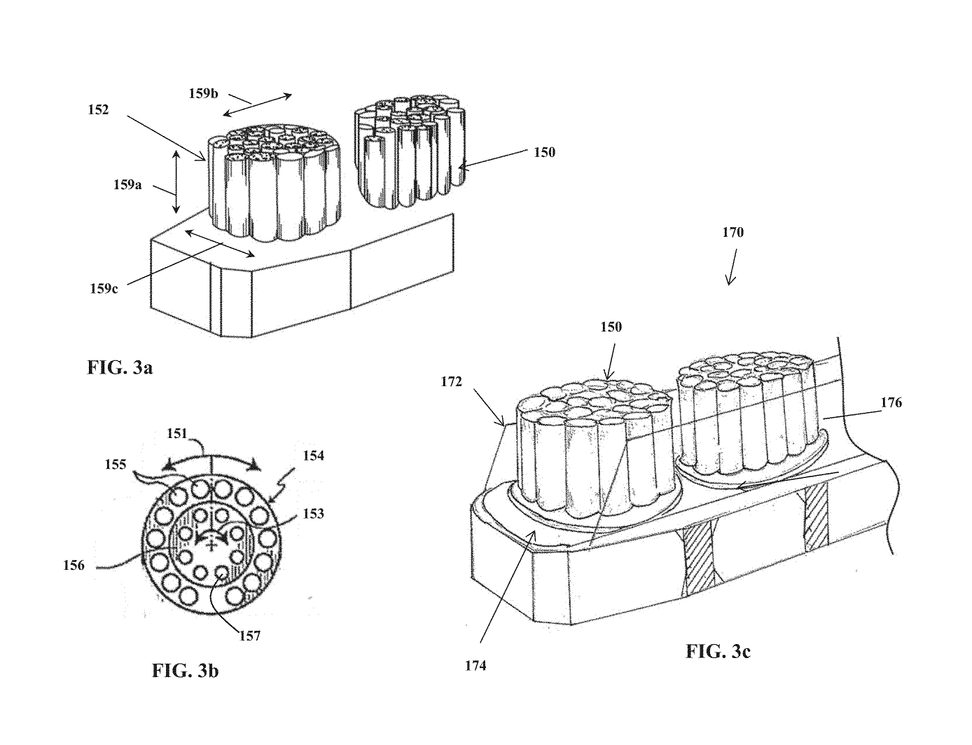

In an alternative embodiment, the top portion and the bottom portion may include a U-shaped cross-section 170 that includes a plurality of brush heads 150 as shown in FIG. 3c. The U-shaped cross-section conforms to the shape of the teeth and brushes individual teeth or a plurality of teeth. The U-shaped cross-section includes a first surface 172 perpendicular to a second surface 174, and the second surface 174 is perpendicular to a third surface 176.

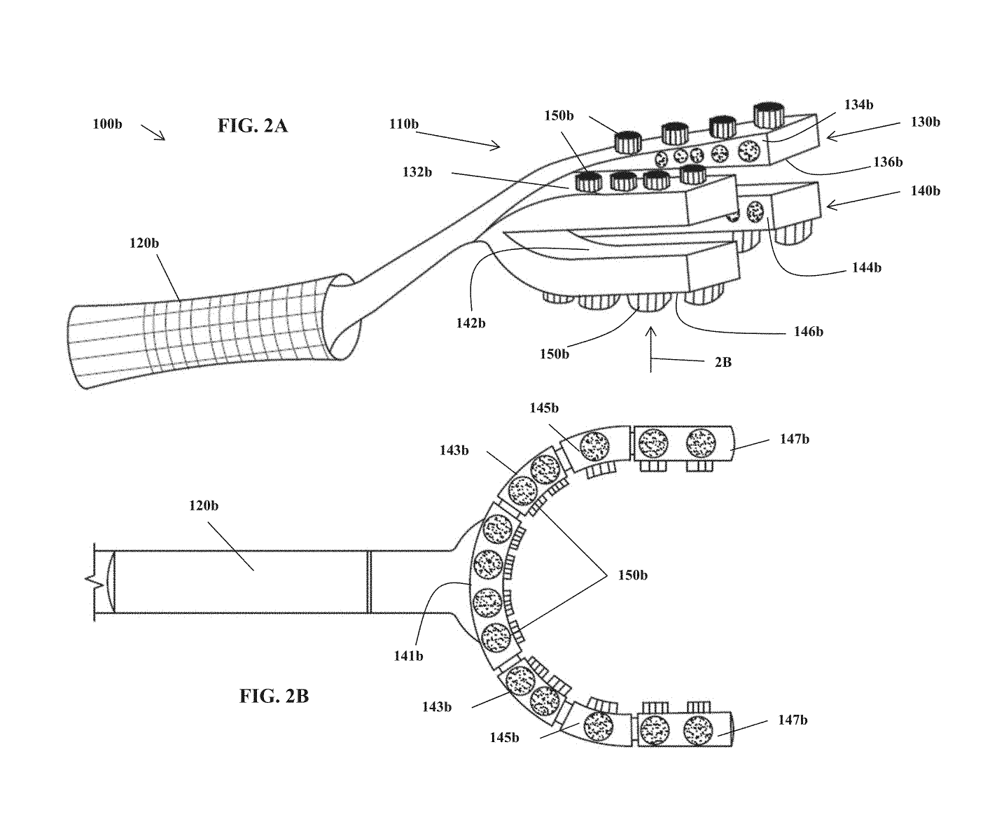

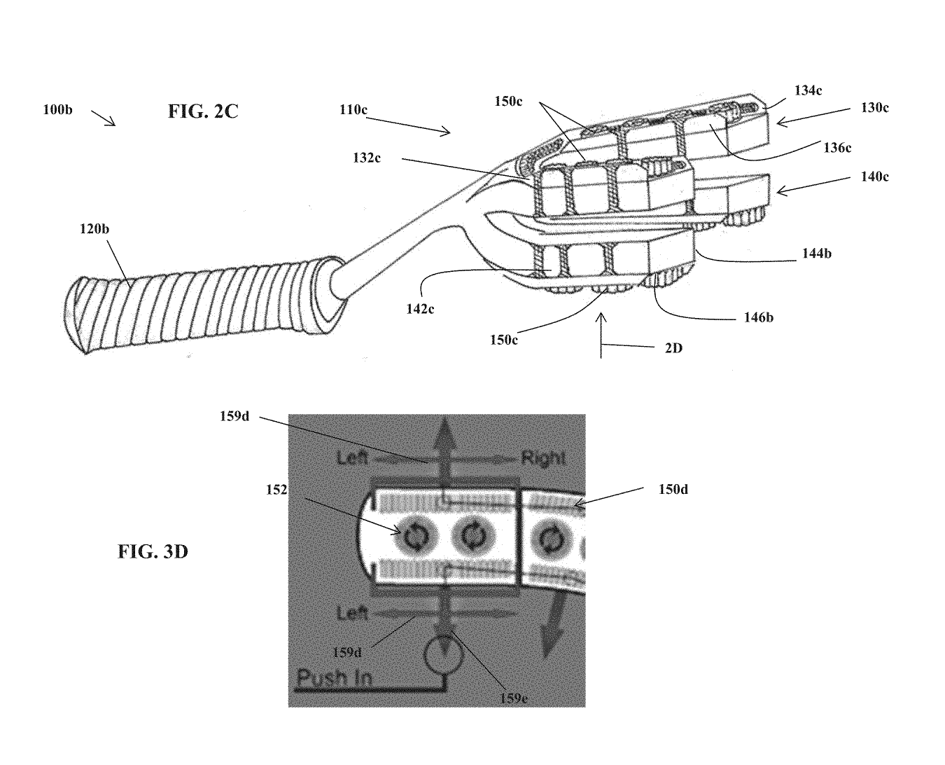

Another embodiment of the tooth brush apparatus 100b is shown in FIG. 2A and comprises a mouthpiece configuration 110b operably coupled to a handle 120b. The mouth piece configuration 110b includes a top portion 130b and a bottom portion 140b, whereby the top portion 130b and the bottom portion 140b include a plurality of brush heads 150b. The top portion 130b includes a top surface 132b, a side surface 134b, and a bottom surface 136b. The bottom portion 140b includes a top surface 142b, a side surface 144b, and a bottom surface 146b. The plurality of brush heads 150b are preferably disposed on the top surface 132b and side surface 134b of the top portion 130b. The plurality of brush heads 150b are preferably disposed on the side surface 144b and bottom surface 146b of the bottom portion 140b. The plurality of brush heads 150b are operably coupled to drive mechanism that provides a brushing action, as further described below. The plurality of brushing heads 150b are configured on each surface of the top portion 130b and the bottom portion 140b to brush every tooth in a human mouth. A human mouth has 32 teeth, which (except for wisdom teeth) includes incisors (8 total): The middlemost four teeth on the upper and lower jaws; canines (4 total): The pointed teeth just outside the incisors; premolars (8 total): Teeth between the canines and molars; and molars (8 total). The plurality of brush heads 150b may be the same or different according to the different teeth being cleaned. Accordingly, the top portion 130b and the bottom portion 140 may include different sections of brush heads 150, as shown in FIG. 2B, to accommodate different teeth.

Another embodiment of the tooth brush apparatus 100b is shown in FIG. 2C and comprises a mouthpiece configuration 110c operably coupled to a handle 120c. The mouth piece configuration 110c includes a top portion 130c and a bottom portion 140c, whereby the top portion 130b and the bottom portion 140b include a plurality of brush heads 150b. The top portion 130b includes a top surface 132c, a first side surface 134c, and a second side surface 136c. The bottom portion 140c includes a first side surface 142c, a second side surface 144c, and a bottom surface 146c. The plurality of brush heads 150c are preferably disposed on the top surface 132c and the first and second side surfaces 134c and 136c of the top portion 130c. The plurality of brush heads 150b are preferably disposed on the bottom surface 146c and the first and second side surfaces 144c and 142c of the bottom portion 140c. The plurality of brush heads 150c are preferably disposed on the side surface 144c and bottom surface 146c of the bottom portion 140c. The plurality of brush heads 150b are operably coupled to drive mechanism that provides a brushing action, as further described below. The plurality of brushing heads 150c are configured on each surface of the top portion 130c and the bottom portion 140c to brush every part of the tooth in a human mouth. A human mouth has 32 teeth, which (except for wisdom teeth) includes incisors (8 total): The middlemost four teeth on the upper and lower jaws; canines (4 total): The pointed teeth just outside the incisors; premolars (8 total): Teeth between the canines and molars; and molars (8 total). The plurality of brush heads 150b may be the same or different according to the different teeth being cleaned. Accordingly, the top portion 130c and the bottom portion 140c may include different sections of brush heads 150c, as shown in FIG. 2D, to accommodate different teeth.

The bottom portion 140b is shown FIG. 2B for representative purposes but may also be the top portion 130b. The bottom portion 140b includes a first section 141b, a second section 143b, a third section 145b, and fourth section 147b. The top portion 130b may include a first section, a second section, a third section, and fourth section (not shown). The first section may be adapted for the incisors, the second section may be adapted for the canines, the third section may be adapted for the premolars, and fourth section may be adapted for the molars. Alternatively, the top portion may be adapted for the teeth on the maxillary bone or top jaw bone, while the bottom portion may be adapted for teeth on the mandible bone or bottom jaw bone.

The human tooth anatomy includes 8 incisors as the anterior teeth, 4 in the upper arch and 4 in the lower and their function is for shearing or cutting food during chewing. There are no cusps on the teeth. Instead, the surface area of the tooth used in eating is called the incisal ridge or incisal edge. Though similar, there are some minor differences between the primary and permanent incisors. The first section may be adapted for the incisors; alternatively, the first section of the top portion and the first section of the bottom portion may be adapted for the different incisors on the maxillary portion (top jaw bone) or the mandibular portion (bottom jaw portion), as further explained below.

The first section of the top portion may be adapted for the maxillary central incisors, which are usually the most visible teeth, since they are the top center two teeth in the front of a mouth, and they are located mesial to the maxillary lateral incisor. The overall length of the deciduous maxillary central incisor is 16 mm on average, with the crown being 6 mm and the root being 10 mm. In comparison to the permanent maxillary central incisor, the ratio of the root length to the crown length is greater in the deciduous tooth. The diameter of the crown mesiodistally is greater than the length cervicoincisally, which makes the tooth appear wider rather than taller from a labial viewpoint. The permanent maxillary central incisor is the widest tooth mesiodistally in comparison to any other anterior tooth. It is larger than the neighboring lateral incisor and is usually not as convex on its labial surface. As a result, the central incisor appears to be more rectangular or square in shape. The mesial incisal angle is sharper than the distal incisal angle. When this tooth is newly erupted into the mouth, the incisal edges have three rounded features called mammelons. Mammelons disappear with time as the enamel wears away by friction. The maxillary lateral incisor is the tooth located distally from both maxillary central incisors of the mouth and mesially from both maxillary canines. The first section of the bottom portion may be adapted for the mandibular central incisor, which is the tooth located on the jaw, adjacent to the midline of the face. It is mesial from both mandibular lateral incisors. The first section of the bottom portion may be adapted for the mandibular lateral incisor, which is the tooth located distally from both mandibular central incisors of the mouth and mesially from both manibular canines.

The second section of the top portion may be adapted for the maxillary canines, and the second portion of the bottom portion may be adapted for the mandibular canines. Both the maxillary and mandibular canines are called the “cornerstone” of the mouth because they are all located three teeth away from the midline, and separate the premolars from the incisors. The location of the canines reflect their dual function as they complement both the premolars and incisors during chewing. Nonetheless, the most common action of the canines is tearing of food. There is a single cusp on canines, and they resemble the prehensile teeth found in carnivorous animals. Though similar, there are some minor, the maxillary canine is the tooth located laterally from both maxillary lateral incisors of the mouth but mesially from both maxillary first premolars. It is the longest tooth in total length, from root to the incisal edge, in the mouth. The mandibular canine is the tooth located distally from both mandibular lateral incisors of the mouth but mesially from both mandibular first premolars.

The third section of the top portion may be adapted for the maxillary premolars and the third section of the bottom portion may be adapted for the mandibular premolars. Premolars are found distal to canines and mesial to molars. They are divided into first and second premolars. The functions of premolars vary. There are no deciduous premolars. Instead, the teeth that precede the permanent premolars are the deciduous molars. The maxillary first premolar is the tooth located laterally from both the maxillary canines of the mouth but mesially from both maxillary second premolars. The function of this premolar is similar to that of canines in regard to tearing being the principal action during chewing. There are two cusps on maxillary first premolars, and the buccal cusp is sharp enough to resemble the prehensile teeth found in carnivorous animals. There is a distinctive concavity on the cervical third of the crown extending onto the root. The maxillary 1st premolar is also bifurcated with two roots. The maxillary second premolar is the tooth located laterally from both the maxillary first premolars of the mouth but mesially from both maxillary first molars. The function of this premolar is similar to that of first molars in regard to grinding being the principal action during chewing. There are two cusps on maxillary second premolars, but both of them are less sharp than those of the maxillary first premolars. The mandibular first premolar is the tooth located laterally from both the mandibular canines of the mouth but mesially from both mandibular second premolars. The function of this premolar is similar to that of canines in regard to tearing being the principal action during mastication. Mandibular first premolars have two cusps. The one large and sharp is located on the buccal side of the tooth. Since the lingual cusp is small and nonfunctional, which means it is not active in chewing, the mandibular first premolar resembles a small canine. The mandibular second premolar is the tooth located distally from both the mandibular first premolars of the mouth but mesially from both mandibular first molars. The function of this premolar is to assist the mandibular first molar during mastication. Mandibular second premolars have three cusps. There is one large cusp on the buccal side of the tooth. The lingual cusps are well developed and functional, which means the cusps assist during chewing. Therefore, whereas the mandibular first premolar resembles a small canine, the mandibular second premolar is more like the first molar.

The fourth section of the top portion and the bottom portion may be adapted for the molars. Molars are the most posterior teeth in the mouth. Their function is to grind food during chewing. The number of cusps, and thus the overall appearance, vary among the different molars and between people. There are great differences between the deciduous molars and those of the permanent molars, even though their functions are similar. Permanent maxillary molars are not considered to have any teeth that precede them. Despite being named “molars”, the deciduous molars are followed by permanent premolars. The third molars are commonly called “wisdom teeth.”

The maxillary first molar is the tooth located laterally from both the maxillary second premolars of the mouth but mesially from both maxillary second molars. There are usually four cusps on maxillary molars, two on the buccal and two palatal. Most times there is also a fifth cusp, called the Cusp of Carabelli, located on the mesiolingual aspect of the tooth. The maxillary second molar is the tooth located laterally from both the maxillary first molars of the mouth but mesially from both maxillary third molars. This is true only in permanent teeth. In deciduous teeth, the maxillary second molar is the last tooth in the mouth and does not have a third molar behind it. The deciduous maxillary second molar is also the most likely of the deciduous teeth to have an oblique ridge. There are usually four cusps on maxillary molars, two buccal and two palatal.

The maxillary third molar is the tooth located laterally from both the maxillary second molars of the mouth with no tooth posterior to it in permanent teeth. In deciduous teeth, there is no maxillary third molar. There are usually four cusps on maxillary molars, two buccal and two palatal. Nonetheless, for this tooth, there are great variances among third molars, and a specific description of a third molar will not hold true in all cases. The mandibular first molar is the tooth located distally from both the mandibular second premolars of the mouth but mesially from both mandibular second molars. It is located on the mandibular arch of the mouth, and generally opposes the maxillary first molars and the maxillary 2nd premolar. This arrangement is known as Class I occlusion. There are usually five well-developed cusps on mandibular first molars: two on the buccal, two lingual, and one distal. The mandibular second molar is the tooth located distally from both the mandibular first molars of the mouth but mesially from both mandibular third molars. This is true only in permanent teeth. In deciduous teeth, the mandibular second molar is the last tooth in the mouth and does not have a third molar behind it. Though there is more variation between individuals to that of the first mandibular molar, there are usually four cusps on mandibular second molars: two buccal and two lingual. The mandibular third molar is the tooth located distally from both the mandibular second molars of the mouth with no tooth posterior to it in permanent teeth. In deciduous teeth, there is no mandibular third molar. For this tooth, there are great variances among third molars, and a specific of a third molar will not hold true in all cases.

Brush Heads

The brush heads 150 may comprise a circular configuration 152, as shown in FIG. 3a. In an alternative embodiment, the brush head 150 may comprise any polygonal configuration, including, but not limited to: a rectangular configuration, a square configuration, a trapezoidal configuration, an oval configuration, and the like. In one embodiment, the brush heads may comprise a first circular block 154 and a second circular block 156, whereby the second circular block 156 is located within the first circular block 154. First circular block 154 includes a plurality of tufts of bristles 155. In the illustrated embodiment the tufts of bristles 155 are formed in a coarcuate row. Similarly, second circular block 156 is provided with a plurality of tufts of bristles 157 which may be also coarcuate with each other along a circle parallel to the arcuate row of bristles 155. The two coarcuate sets of bristles 155, 157 are preferred since such arrangement maximizes bristle density on the surface area of tuft blocks 154 and 156 and if the diameter dimension of the tuft block 156 is sufficient, additional tufts can be located centrally therein. In the preferred practice of the invention the outer row of bristles 155 extend outwardly from the outer surface of head a greater distance than the inner arcuate row of bristles 157. As a result, a cup-like structure is formed which facilitates retaining toothpaste on the bristles 155,157. As shown in FIG. 3b the outer row of bristles 155 extend generally perpendicular to the first circular block 154; however, the outer row of bristles 155 can be splayed outwardly from the first circular block 154 at an acute angle thereto.

The brush heads may be oscillate in order to clean teeth. The brush heads may oscillate by any suitable drive mechanism. As shown therein, a drive shaft is rotated by a driving motor (not shown) in the handle. The motor could be powered in any suitable manner such as by batteries located in the handle. A transmission spindle is operatively connected such as by a permanent or detachable connection to drive shaft. Spindle has a V-segment oriented perpendicularly to the axis of rotation of the drive shaft and eccentrically with respect to the axis of rotation. A first inclined arm engages in an axial slot in first circular block. A second distal arm engages in an axial slot in second circular block. Rotation of shaft and spindle results in rotation of arms. Because the eccentric portions of arms are mounted in slots in circular blocks the rotational movement is transmitted to the circular blocks as an oscillating rotational movement shown by the arrows 151 and 153 of FIG. 3a. As driven by the spindle, the rotational movement of first circular block will be opposite in direction from that of second circular block.

Vibration

For example, the circular configuration of the brush head may move in and out in a direction generally perpendicular to the outer surface of head 150 generally shown as arrow 159a, as shown in FIG. 3a. This would result in a vibrating section. Any suitable drive mechanism may be used to accomplish this in and out vibrating motion. Alternatively the vibrating section could be free floating without a positive drive. The resulting in and out motion is indicated by the arrow 159a in FIG. 3a. Other forms of movement of circular configuration 152 could be as indicated by the arrow 159b in FIG. 3a where the movement is longitudinal with respect to the longitudinal axis of head 150 or could be lateral as indicated by the arrow 159c of FIG. 3a. Any suitable drive mechanism may be used to accomplish these motions which would be in a plane generally parallel to the outer surface of head 150.

As shown in FIG. 3D, the brush heads 150d on the first and second sides may move longitudinally with respect to the circular brush heads on the top or bottom portion, as indicated by arrow 159d. The first and second sides of the top and bottom portions may also move axially with respect to the circular brush heads as to move closer or further away from engaged teeth, as shown by 159e. The axial movement of the first and second sides allows for closer contact of the brush heads 150d to teeth or further away from the teeth for cleaning of more sensitive teeth. The brush heads 152 rotate in a circular motion.

Bristles

Preferably, different types of bristles may be used in the head of the toothbrush. The head may have the traditional nylon or other material bristles as well as rubber bristles. There may be a combination of traditional and rubber bristles on the lateral arms, while the base member may have only the traditional bristles.

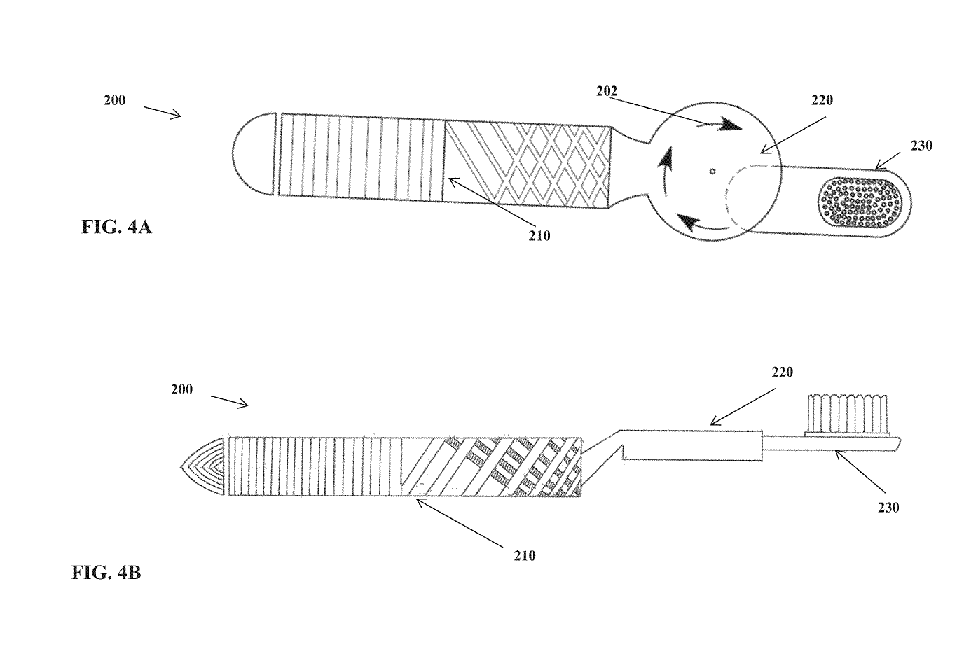

An alternative embodiment of the tooth brush apparatus 200 is shown in FIG. 4a-4b. The tooth brush apparatus includes a handle 210 and a rotating portion 220 operably coupled to a brush head 230. The rotating portion 220 circulates the brush head in the direction of arrow 202. The brush head 230 may be similar to previous brush heads 150 as described previously, or the brush head 230 include substantially fixed bristles. The handle may include a drive mechanism to rotate the rotating portion 220. The rotating portion 220 may rotate clockwise or counterclockwise as to provide a brushing action to clean teeth.

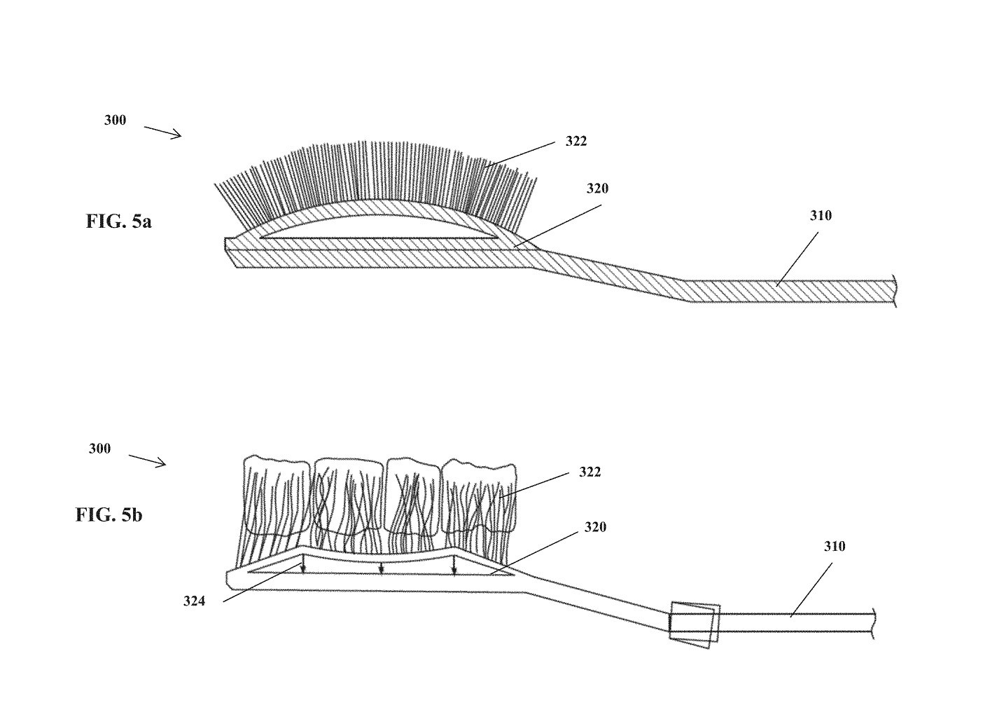

An alternative embodiment of the tooth brush apparatus 300 is shown in FIG. 5a-5b. The tooth brush apparatus 300 includes a handle 310 operably coupled to the brush head 320. The brush head 320 includes a first state and a second state. The first state, as shown in FIG. 5a, is flexed out position of the brush head, whereby the bristles 322 on the brush head open up and separate from adjacent bristles and decrease the density of the bristles per mm². The first state of the brush head 320 includes a generally curvilinear cross-section or profile. As shown in FIG. 5b, the second state of the brush head 320 closes the bristles 322 and causes the bristles to become compact and increase the density of bristles per mm². The brush head 320 closes to the second state in the direction of arrow 324, and allows the brush head 320 with compact bristles 322 to clean the teeth. The first state of the bristles 322 with decreased density of bristles per mm2 opens the bristles to allow sufficient cleaning the bristles and to air dry between the bristles as prevent bacteria or mold growth.

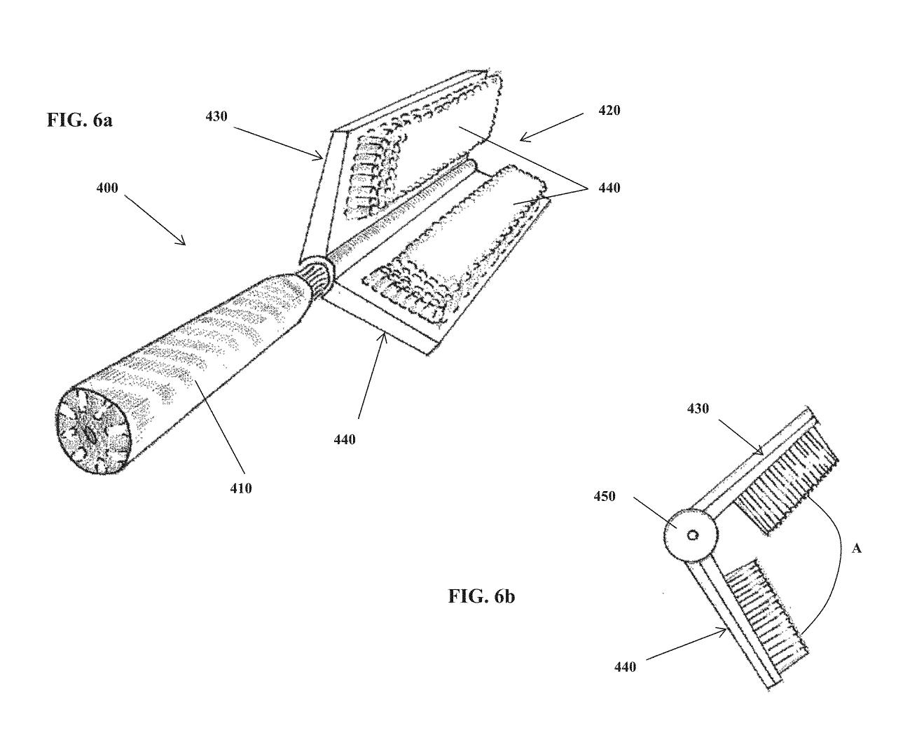

An alternative embodiment of the tooth brush apparatus 400 is shown in FIGS. 6a-6b. The tooth brush apparatus 400 includes a handle 410 operably coupled to a two-prong brush head 420. The two prong brush head 420 includes a first brush head 430 and a second brush head 440. In one embodiment, the first brush head 430 is perpendicular to the second brush head 440. Alternatively, the first brush head 430 may be set an angle A with respect to the second brush head 440, as shown in FIG. 6b. The Angle A may be between 10 degrees and 170 degrees and fully adjustable by the user if so desired. As such, the first brush head 430 and the second brush head 440 may rotate or pivot with respect to the each other and be locked into a fixed position by operation of a pivot 450. The first brush head 430 and the second brush head 440 may include a plurality of bristles, as previously described.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A tooth brush apparatus comprising:
a mouthpiece configuration operably coupled to a handle, the mouth piece configuration including a top portion and a bottom portion, whereby the top portion and the bottom portion include a plurality of brush heads;
the top portion includes a top surface, a first side surface, and a second side surface, the plurality of brush heads are disposed on the top surface, the first side surface, and the second side surface of the top portion;
the bottom portion includes a top surface, a first side surface, and a second side surface, the plurality of brush heads are disposed on the top surface, the first side surface, and the second side surface of the bottom portion; and
the plurality of brush heads are operably coupled to drive mechanism that provides a brushing action, and the plurality of brushing heads are configured on each surface of the top portion and the bottom portion to brush every tooth in a human mouth.

2. The tooth brush apparatus of claim 1, wherein the top surface of the bottom portion is set at angle with respect to the first side surface of the bottom portion and the second side surface of the bottom portion, wherein the angle is between 75 degrees and 110 degrees. The angle may be selected according to the type of teeth being cleaned or brushed and what section of the bottom portion 140a the brush heads are disposed.

3. The tooth brush apparatus of claim 2, wherein the top portion includes a first section, a second section, a third section, and fourth section; and the bottom portion includes a first section, a second section, a third section, and fourth section, wherein the first section is be adapted for the incisors, the second section is adapted for the canines, the third section is adapted for the premolars, and the fourth section is adapted for the molars.

4. The tooth brush apparatus of claim 3, wherein the top portion is adapted for the teeth on the maxillary bone or top jaw bone, and the bottom portion is adapted for teeth on the mandible bone or bottom jaw bone.

5. The tooth brush apparatus of claim 4, wherein the top portion and the bottom portion include a U-shaped cross-section conforming to the shape of the teeth, and the U-shaped cross-section includes a first surface perpendicular to a second surface, and the second surface is perpendicular to a third surface.

6. The tooth brush apparatus of claim 5, furthering comprising a handle operably coupled the mouthpiece configuration.

7. The tooth brush apparatus of claim 6, wherein the brush heads comprise a circular configuration.

8. The tooth brush apparatus of claim 7, the brush heads may comprise a first circular block and a second circular block, whereby the second circular block is located within the first circular block.

9. The tooth brush apparatus of claim 8, wherein the brush heads oscillate by a drive mechanism including a drive shaft is rotated by a driving motor in the handle.

10. The tooth brush apparatus of claim 9, wherein the driving motor is operably coupled to a transmission spindle to translate rotational movement to the first and second circular blocks as an oscillating rotational movement.

11. The tooth brush apparatus of claim 7, wherein the circular configuration of the brush head move in and out in a direction generally perpendicular to the outer surface of head resulting in a vibrating section.

12. A tooth brush apparatus comprising a handle and a rotating portion operably coupled to a brush head, wherein the rotating portion circulates the brush head, the handle includes a drive mechanism to rotate the rotating portion.

13. A tooth brush apparatus comprising a handle operably coupled to the brush head, wherein the brush head includes a first state and a second state; the first state is flexed out position of the brush head, whereby the bristles on the brush head open up and separate from adjacent bristles and decrease the density of the bristles per mm²; the first state of the brush head includes a generally curvilinear cross-section or profile; the second state of the brush head closes the bristles and causes the bristles to become compact and increase the density of bristles per mm².

14. The tooth brush apparatus of claim 13, the brush head closes to the second state with compact bristles to clean teeth; and the first state of the bristles with decreased density of bristles per mm² opens the bristles to allow sufficient cleaning the bristles and to air dry between the bristles as prevent bacteria or mold growth.
